(19) United States
(12) Patent Application Publication
(10) Pub. No.: US 2023/0316328 A1
(43) Pub. Date: Oct. 5, 2023

(54) SYSTEM AND METHOD FOR JOINT PREDICTIVE MODELING OF MULTIPLE TARGETING SEGMENTS

(71) Applicant: YAHOO ASSETS LLC, Dulles, VA (US)

(72) Inventors: Martin Pavlovski, San Jose, CA (US); Djordje Gligorijevic, San Jose, CA (US); Jelena Gligorijevic, San Jose, CA (US); Ivan Stojkovic, San Jose, CA (US); Srinath Ravindran, Fremont, CA (US); Shubham Agrawal, San Jose, CA (US); Narayan Bhamidipati, Dublin, CA (US)

(21) Appl. No.: 17/711,547

(22) Filed: Apr. 1, 2022

(51) Int. Cl. G06Q 30/02; G06N 20/00

(52) U.S. Cl. CPC G06Q 30/0269; G06N 20/00; G06Q 30/0242; G06Q 30/0277

(57) ABSTRACT

This teaching relates to predictive targeting. Training data are obtained with pairs of data. Each pair includes an ad opportunity context corresponding to an ad served to a plurality of audiences and a label vector having a plurality of labels, each of which indicates a reaction, with respect to the ad served, of a corresponding one of the audiences in the ad opportunity context. Based on the training data, model parameters of a joint predictive model are learned via machine learning based on an initialized model with initial model parameters by minimizing a loss in an iterative process. The learned joint predictive model is to be used to map an input context of an ad opportunity to an output label vector having a plurality of probabilities, each of which predicts a likelihood of a reaction of a corresponding one of the audiences to the input context of the ad opportunity.

### 1. TECHNICAL FIELD

The present teaching generally relates to data processing. More specifically, the present teaching relates to big data analytics and modeling thereof.

### 2. TECHNICAL BACKGROUND

With the development of the Internet and the ubiquitous network connections, more and more commercial and social activities are conducted online. Digitized content is served or recommended online to millions of users. Advertisements are displayed to the users while they consume the digitized content, and the users can interact with the ads by either viewing them or clicking on them to visit the advertiser's webpage, where they may make a purchase. To make online advertising more effective, targeting has been practiced. This includes targeting users from the perspective of advertisers and selecting appropriate ads for online users who may be interested in the content of the ads. Targeting related processing is usually behind the scenes and the goal is to match each ad with the user segments that are most likely to react to the ads positively in order to maximize the financial return. Ad targeting involves prediction of which segments a user or an ad opportunity context belongs to, from a very large list of possible segments. These segment-related products include interest segments, predictive audiences, . . . , lookalike segments, as illustrated in FIG. 1A.

There are various challenges in ad targeting. First, traditionally, targeting is performed through modeling users based on observed past user online behavior or preferences. It is commonly known that over the years, tracking user online activities has been widely achieved via, e.g., cookies. However, in recent years, the cookies have been gradually phased out and this trend is continuing. In this brave new cookieless world, tracking and understanding user preferences and online behavior becomes unattainable. Given that, some targeting products for producing user-based audiences and segments for advertisers to target started to shift to contextual based modeling counterparts. In many situations, such contextual based targeting products share most of the properties with the user-based counterpart products. This is particularly the case when so-called “panel users” (i.e., a set of users whose online behavior can be tracked, and can serve as exemplars of the desired behavior or preferences) are used to build models for Predictive Audiences (PA) and Lookalike Segments (LAL).

The second challenge has to do with modeling capacity and scalability. Current solutions treat an underlying prediction problem (e.g., predicting the probability of conversion or click through rate) as a binary classification problem. This kind of solution leverages a separate binary classifier or model for estimating the conversion probability for each of the targeting segments. This is depicted in FIG. 1B (PRIOR ART). As seen, for each of the K segments (i.e., segment 1 110-1, segment 2 110-2, . . . , segment i 110-i, . . . , and segment K 110-K), there is a separately trained prediction model (i.e., prediction model 1 120-1, prediction model 2 120-2, . . . , prediction model i 120-i, . . . , and prediction model K 120-K), respectively. As such, there are also separate prediction units (i.e., prediction unit 1 130-1, prediction unit 2 130-2, . . . , prediction unit i 130-i, . . . , and prediction unit K 130-K) for predicting the performance (e.g., conversion probabilities P1, P2, . . . , Pi, . . . , Pk) of different respective segments based on respective prediction models. Based on the separately predicted probabilities, a prediction based segment selector 140 then selects one or more segments as the targets.

An ad serving system using such traditional solutions is depicted in FIG. 1C (PRIOR ART), where information collected from operation is stored in data store 170 as training data. In order to generate learned models 120 for different segments, features are extracted by different feature generators 180 from the training data, which are then used to train the models, via separate machine learning processes 190. In operation, when an ad request associated with a user 100 is sent from the user device to a supply side platform (SSP) 150, a demand side platform (DSP) 160 invokes different context based segment selectors 130 therein to load separate trained models 120 for different segments in order to select segments that exceed some, e.g., pre-determined performance criteria. As seen in FIG. 1C, the prediction and selection are carried out separately with respect to different segments, whether it is interest segments, PA segments, or lookalike segments.

Formulating the prediction problem this way leads to undesirable consequences, including lower predictive power of the models, inability to consider the interactions among different segments, and wasted hardware and computing times.

Thus, there is a need for a solution that addresses the challenges discussed above, and to enhance the operations in ad targeting.

### SUMMARY

The teachings disclosed herein relate to methods, systems, and programming for information management. More particularly, the present teaching relates to methods, systems, and programming related to hash table and storage management using the same.

In one example, a method, implemented on a machine having at least one processor, storage, and a communication platform capable of connecting to a network for predictive targeting. Training data are obtained with pairs of data. Each pair includes an ad opportunity context corresponding to an ad served to a plurality of audiences and a label vector having a plurality of labels, each of which indicates a reaction, with respect to the ad served, of a corresponding one of the plurality of audiences in the ad opportunity context. Based on the training data, model parameters of a joint predictive model are learned via machine learning based on an initialized model with initial model parameters by minimizing a loss in an iterative process. The learned joint predictive model is to be used to map an input context of an ad opportunity to an output label vector having a plurality of probabilities, each of which predicts a likelihood of a reaction of a corresponding one of the plurality of audiences to the input context of the ad opportunity.

In a different example, a system is disclosed for predictive targeting, including a training data generator, a model initializer, and a machine learning controller. The training data generator is configured for generating training data comprising pairs of data, each of the pairs includes an ad opportunity context corresponding to an ad served to a plurality of audiences and a label vector having a plurality of labels, each of which indicates a reaction, with respect to the ad served, of a corresponding one of the plurality of audiences in the ad opportunity context. The model initializer is configured for initializing a joint predictive model with initial model parameters. The machine learning controller is configured for machine learning, based on the training data, model parameters of the joint predictive model based on the initial model parameters by minimizing a loss in an iterative process, where the learned joint predictive model is to be used to map an input context of an ad opportunity to an output label vector having a plurality of probabilities, each of which predicts a likelihood of a reaction of a corresponding one of the plurality of audiences to the input context of the ad opportunity.

Other concepts relate to software for implementing the present teaching. A software product, in accordance with this concept, includes at least one machine-readable non-transitory medium and information carried by the medium. The information carried by the medium may be executable program code data, parameters in association with the executable program code, and/or information related to a user, a request, content, or other additional information.

Another example is a machine-readable, non-transitory and tangible medium having information recorded thereon for predictive targeting. The information, when read by the machine, causes the machine to perform various steps. Training data are obtained with pairs of data. Each pair includes an ad opportunity context corresponding to an ad served to a plurality of audiences and a label vector having a plurality of labels, each of which indicates a reaction, with respect to the ad served, of a corresponding one of the plurality of audiences in the ad opportunity context. Based on the training data, model parameters of a joint predictive model are learned via machine learning based on an initialized model with initial model parameters by minimizing a loss in an iterative process. The learned joint predictive model is to be used to map an input context of an ad opportunity to an output label vector having a plurality of probabilities, each of which predicts a likelihood of a reaction of a corresponding one of the plurality of audiences to the input context of the ad opportunity.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1A-1C describe issues associated with ad targeting and prior art solutions;

FIG. 2 depicts a framework for ad targeting via joint predictive modeling of multiple targeting segments, in accordance with an embodiment of the present teaching;

FIG. 3 depicts an ad serving system with ad targeting via joint predictive modeling of multiple targeting segments, in accordance with an embodiment of the present teaching;

FIG. 4A is a flowchart of an exemplary process for an ad serving system with ad targeting based on joint predictive modeling of all segments, in accordance with an exemplary embodiment of the present teaching;

FIG. 4B is a flowchart of an exemplary process of ad targeting via joint predictive modeling of all segments, in accordance with an embodiment of the present teaching;

FIG. 5 depicts an exemplary high level system diagram of a model training unit for learning a joint predictive model, in accordance with an exemplary embodiment of the present teaching;

FIG. 6 is a flowchart of an exemplary process of a model training unit for learning a joint predictive model, in accordance with an exemplary embodiment of the present teaching;

FIG. 7 is an illustrative diagram of an exemplary mobile device architecture that may be used to realize a specialized system implementing the present teaching in accordance with various embodiments; and

FIG. 8 is an illustrative diagram of an exemplary computing device architecture that may be used to realize a specialized system implementing the present teaching in accordance with various embodiments.

### DETAILED DESCRIPTION

In the following detailed description, numerous specific details are set forth by way of examples in order to facilitate a thorough understanding of the relevant teachings. However, it should be apparent to those skilled in the art that the present teachings may be practiced without such details. In other instances, well known methods, procedures, components, and/or systems have been described at a relatively high-level, without detail, in order to avoid unnecessarily obscuring aspects of the present teachings.

The present teaching discloses solutions that address challenges in ad targeting. To avoid modeling individual segments separately as in the traditional approaches, the present teaching relates to an integrated joint predictive approach for simultaneously predicting conversion probabilities of a large number of audience segments. To do so, a joint predictive model is trained via machine learning based on data related to all audience segments. In some embodiments, the joint predictive modeling is formulated as an extreme multi-label classification (XMLC) problem, which leverages the benefits of the conventional Factorization Machine (FM) model for the purpose of joint multi-audience conversion prediction. The present teaching discloses a solution that addresses the issue related to unavailable user identifiers, focusing on performance (e.g., conversion) prediction based on cookieless traffic involving several thousands of contextual predictive audiences.

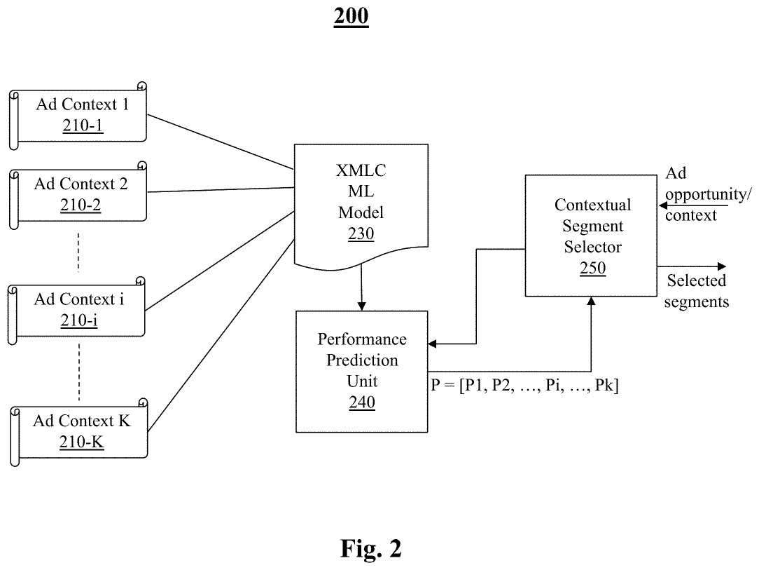

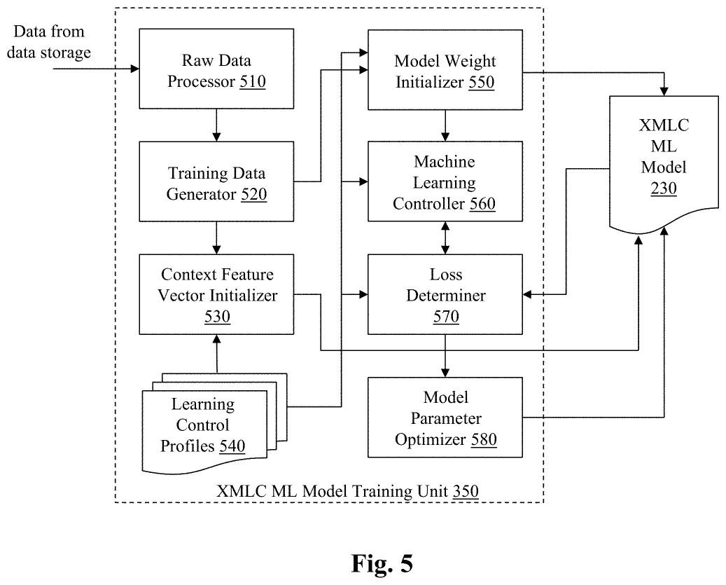

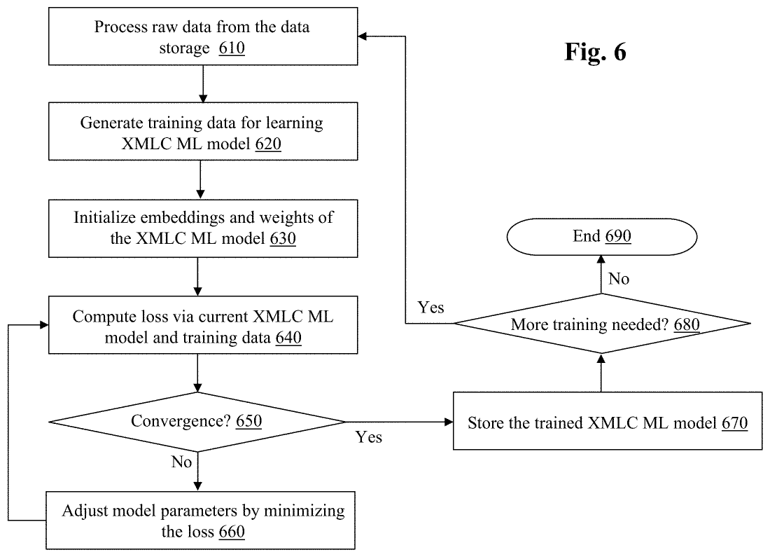

FIG. 2 depicts an exemplary high-level framework 200 for ad targeting via joint predictive modeling of multiple targeting segments, in accordance with an embodiment of the present teaching. In some embodiments, ad context based modeling (as opposed to user-based modeling) may be adopted. To facilitate context based modeling, ad context data associated with different ad display opportunities and environments are collected, including ad context 1 210-1, ad context 2 210-2, . . . , ad context i 210-i, . . . , and ad context K 210-K. Such collected ad contexts reflect the surrounding parameters with respect to different ad displays and such contextual information does not rely on user identity tracking and is able to get around the challenges faced in a cookieless environment. In some embodiments, the ad contexts may also include the information on users' performance, such as clicks and conversions. All collected ad context data 210 may be used to train an integrated joint predictive model or XMLC ML model 230. As will be disclosed below, the learning is formulated in such a manner that the trained model is used to simultaneously predict the probability of certain performance measures (such as conversion) for all user segments based on the context of an ad opportunity. Details related to the training data on ad contexts, the detailed formulation of the XMLC ML model 230, as well as the machine learning process are provided with reference to FIGS. 5-6.

In framework 200, the learned XMLC ML model 230 is used to predict jointly the performance of a large number of segments. When an ad opportunity is presented with given context, a contextual segment selector 250 invokes a performance prediction unit 240, which estimates the probabilities of performance of all segments of users based on the XMLC ML model 230 and generates a probability vector P=[P1, P2, . . . , Pi, . . . , Pk], wherein each attribute in the probability vector represents the probability of performance (e.g., conversion) for a corresponding user segment. Based on the probability vector P, the contextual segment selector 250 then selects one or more segments as the target segments.

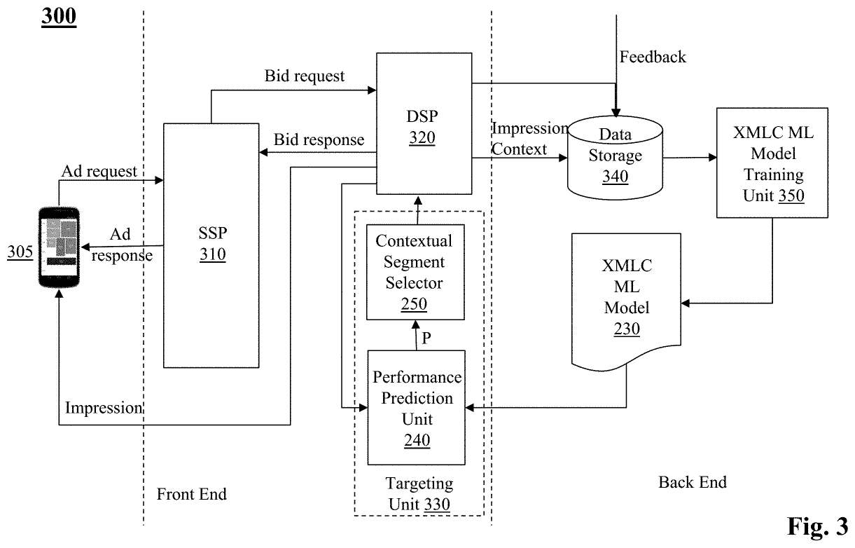

The framework as depicted in FIG. 2 may be employed in an ad serving system to provide ad targeting. FIG. 3 depicts an exemplary construct of an ad serving system 300 with ad targeting capability achieved via joint predictive modeling of multiple targeting segments, in accordance with an embodiment of the present teaching. The ad serving system 300 includes a front-end portion and a backend portion. The front end comprises an SSP 310, a DSP 320, and a targeting unit 330. The SSP 310 in the front-end interfaces with a user device 305, including receiving an ad request from the device and providing an ad response to the device. When a user with the user device 305 visits a web page, it creates a display opportunity. The SSP 310 generates an ad bid request and sends it to one or more DSPs 320. Each of DSPs 320 that receive the bid request provides a bid response indicating the bidding outcome. To do so, the DSP 320 invokes the targeting unit 330 to receive target segments selected by the targeting unit 330.

The targeting unit 330 includes the performance prediction unit 240 and the contextual segment selector 250. As discussed herein, the performance prediction unit 240 is provided to estimate, based on the XMLC ML model 230, a probability vector P with probabilities with respect to a large number of segments of predicted performance given the context associated with the current ad display opportunity. The contextual segment selector 250 is provided to select, based on the predicted performance probabilities for all segments, one or more segments as the targeted segments. In some embodiments, the targeting unit 330 may be implemented as a part of the DSP 320. In some embodiments, the target unit 330 may be provided as an independent service provider residing outside of the DSP 320 or even outside of the ad serving system 300.

In the illustrated embodiment, the back end of the ad serving system 300 is provided to establish and update the XMLC ML model 230 so that the XMLC ML model 230 can be used by the targeting unit 330 to target user segments. In FIG. 3, the back end includes a data storage 340, an XMLC ML model training unit 350, and the XMLC ML model 230. When the DSP 320 sends an impression of an ad to device 305 for display, it sends the ad displayed, and the associated context of the impression of the ad to the data storage 340 as collected training data. In addition, feedback of user reaction, e.g., conversion or click, to the ad impression may also be stored in data storage 340. Such collected data are then used by the XMLC ML model training unit 350 to learn the XMLC ML model 230. As can be seen in FIG. 3, the ad serving system 300 has only one prediction model, i.e., the XMLC ML model 230, for predicting performance probabilities for all segments. As such, there is also one performance prediction unit 240 that is capable of predicting the performances of all segments simultaneously based on the XMLC ML model 230. This overcomes the problems of the traditional solutions with a model that has a significantly improved predictive power, enhanced ability to scale the prediction to support a larger number of segments, and, as will be seen below, is able to consider interactions among different segments and features with reduced hardware requirement and computation time. Details on how such collected data are used in training the XMLC ML model 230 are provided with reference to FIGS. 5-6.

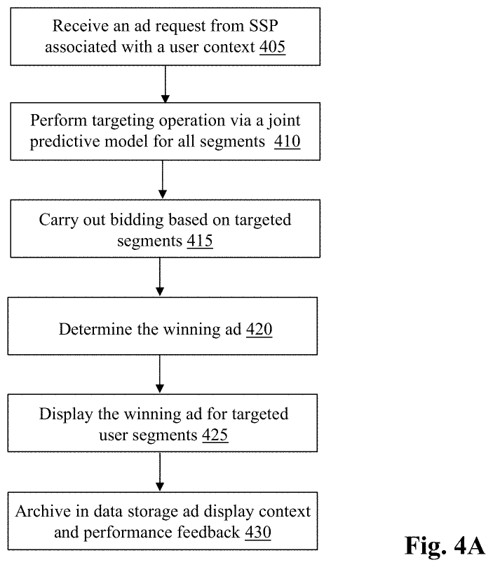

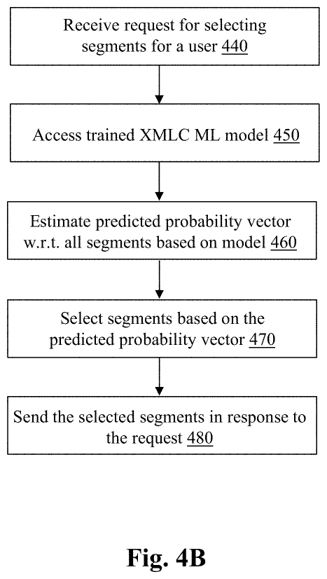

FIG. 4A is a flowchart of an exemplary process for the ad serving system 300 based on ad targeting based on joint predictive modeling of all segments, in accordance with an exemplary embodiment of the present teaching. In operation, when DSP 320 receives, at 405 from the SSP 310, an ad request with contextual information associated with a user/device 305, the DSP 320 performs targeting operation at 410. As discussed herein, ad targeting is performed by the targeting unit 330, which is either a part of the DSP 320 or an independent service provider for targeting related services. FIG. 4B is a flowchart of an exemplary process of ad targeting via joint predictive modeling of all segments, in accordance with an embodiment of the present teaching. When the targeting unit 330 receives, at 440, a request for selecting targeted segments based on the context associated with an ad display opportunity, the performance prediction unit 240 accesses, at 450, the previously trained XMLC ML model 230 and then estimates, at 460, the probability vector P with probabilities of performance (e.g., conversion) with respect to all segments modeled given the input ad display context.

Taking the probability vector P as input, the contextual segment selector 250 selects, at 470, targeted segments according to some pre-determined selection criteria. Such targeted segments are then sent, as the output of the targeting unit 330, to the DSP 320. As shown above, the probability vector includes a plurality of probabilities, each of which corresponds to an estimated probability that a corresponding user segment achieves a certain performance (such as a conversion) given the contextual information associated with the ad opportunity. When multiple DSPs are involved, each of the DSPs performs their respective targeting with their selected segments. In some embodiments, the XMLC ML model 230 may be shared among multiple DSPs and may be trained based on training data from such DSPs. In some embodiments, each DSP may be associated with its own XMLC ML model, trained based on training data from the DSP.

Referring back to FIG. 4A, based on the selected user segments, the DSP carries out the bidding at 415. When a winning ad is determined at 420, the DSP that gives rise to the winning ad provides an impression or display of the winning ad for the targeted used segments at 425 to have the winning ad to be presented to the user on device 305. To facilitate future learning or updating of the XMLC ML model 230, the context associated with the displayed winning ad is sent to the data storage 340 to be archived at 430. In some embodiments, the performance feedback from the user, e.g., a conversion event, is also archived in 340. Such archived data may be used for training the XMLC ML model 230 or updating the model based on continually collected data from operations.

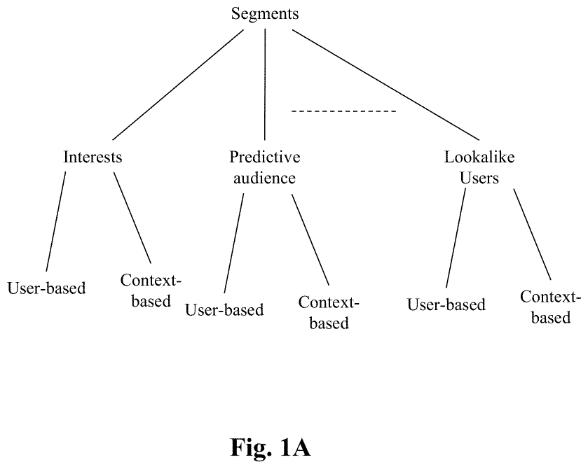

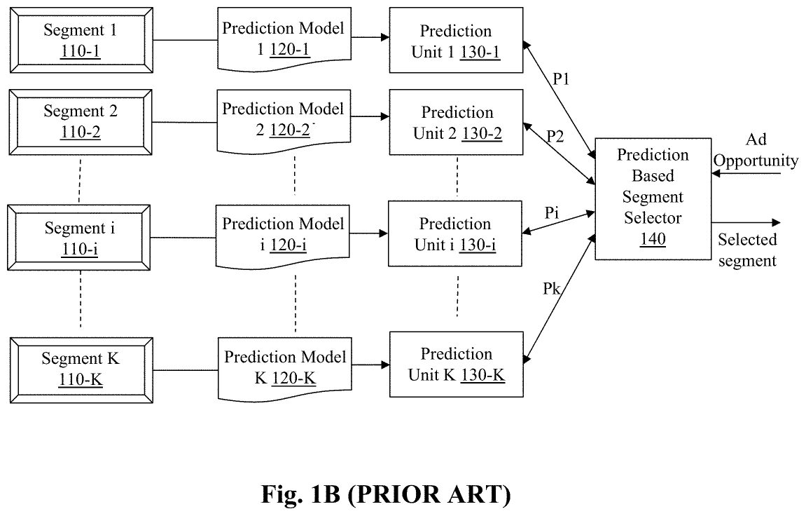

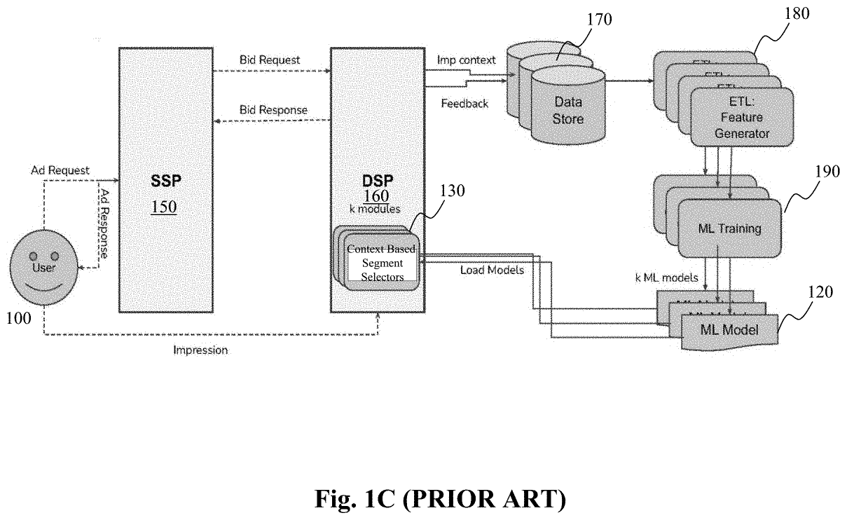

The improvement facilitated by the ad serving system 300 as compared with the traditional ad serving system depicted in FIG. 1C (PRIOR ART) is keyed on the XMLC ML model 230. Below, the formulation of the XMLC ML model as well as the learning mechanism is discussed herein. To cope with the aforementioned challenges, in some embodiments, the problem of conversion prediction across a large number of contextual predictive audiences is formulated as an extreme multi-label classification (XMLC) problem. A multi-label variant of the factorization machine (FM) model is utilized to capture feature interactions and to enable jointly estimation of the conversion probabilities for all considered audiences at once.

First, the formulation of the conversion prediction problem across multiple (and a potentially large number of) contextual predictive audiences is presented herein in the form of an extreme multi-label classification problem, where each label represents an audience. Let S={(x₁, y₁), (x₂, y₂), . . . , (x_{N}, y_{N})} be a set of labeled contexts of ad opportunities. An ad opportunity context xᵢ∈ [symbol] corresponds to data from the data storage. Such data may be preprocessed so that it (1) represents a concatenation of one-hot encodings of the available contextual fields (e.g., resulting in D features, out of which \hat{D} are active), and (2) is associated with a vector yᵢ∈{0,1}^{L} including conversion labels for L audiences, for each i=1, . . . ,N. Note that y_{i,l} takes a value of 1 or 0 depending on whether or not a conversion was registered for audience l, as an indirect result of xᵢ, ∀l=1, . . . , L. The objective is to learn a function ƒ: [symbol] → [symbol] that maps a context of a given ad opportunity x to a label vector y of estimated conversion probabilities for all contextual audiences. It is noted herein that the terms “label” and “audience” may be used interchangeably. In addition, the problem formulated above may be referred to as multi-audience conversion prediction.

In some embodiments, such (xᵢ, yᵢ) tuples are derived based on data stored in storage 340, which represent a collection of records of contexts of ad opportunities and their corresponding conversions (observed on any platform) across different predictive audiences. In some embodiments, the data collection process may involve three data sources: predictive audience definitions, contextual ad opportunities, and user conversion data. Some procedures may be deployed to extract, filter, and integrate data from different sources.

Regarding definitions of audience, data collection may include selecting records from the database of predictive segments such as tables concerning audience pixels, audience definitions, accounts, interest taxonomies and pixel rules. When such tables are joined, the resulting records includes information about a certain audience's identifier, dot pixel, dot rule, country code, and device screen type. In some embodiments, country codes and screen types may be extracted from the audience definition table. In some embodiments, only active audiences with valid pixel IDs may be considered, stemming from, e.g., a multi-tenant streaming system for real-time ingestion of event data (e.g., conversion events) and segment scoring. Such resulting records may be considered as audience conversion rules.

Regarding geographical location or geolocation, such information included in the audience definitions may be represented by country codes. In some embodiments, when representation of such codes is not compliant with the standardized use of this type of geolocation information across different data sources, such country codes from the audience definitions may be mapped to, e.g., corresponding ISO3 counterparts.

With respect to data related to contextual fields, features describing contexts of ad opportunities may be collected from relevant databases. In some embodiments, ad opportunities may be selected if each ad won an ad auction, the corresponding ad was displayed to a certain user, and a user impression was registered upon displaying the ad. In some embodiments, the data selection may also be limited to only ad opportunities that resulted in traffic-protected, valid, or viewable impressions. For such a set of filtered ad opportunities, some fields may be extracted such as event identifier, user_id, webpage top-level domain (TLD), webpage subdomain, Where On Earth Identifiers (WOEIDs) of city, country and region, a user's local time in terms of day-of-week and hour, device type, device category, operating system, browser type, mobile device manufacturer, mobile model, application name, publisher identifier, publisher category, identifier of the publisher's request, ad layout, ad position, ad placement, bidding host machine, video placement type, video content length, site placement, postal code, video player size, metropolitan area identifier, media channel, connection type, and carrier identifier.

In some embodiments, contextual fields, along with the geolocation field (i.e., the ISO3 country code) may be one-hot encoded, resulting in millions of binary features, each indicating a presence of a certain field's category. In some embodiments, features having a frequency of some present (nonmissing) values, e.g., lower than 5 may be filtered out. The remaining ones may be ordered according to their frequencies so that a certain top number of ordered features (e.g., top 200,000) may be selected. The remaining low-frequency features may be replaced by an additional feature which may be designated to represent an “unknown” category.

With regard to labels on performance, e.g., conversion labels, historical activity trails of users (e.g., from the uat_fact table in the uat database) may be searched through to detect if an audience-targeted conversion rule was detected in any activity within a preset period (e.g., seven days of registering a certain user impression). This may be achieved by joining the selected audience definitions with user activity records based on third party event identifiers associated with the audience definitions (i.e., the activity pixel and activity rule identifiers in the case of UAT). Such operations essentially associate users with binary conversion labels indicating for which advertiser (i.e., as a part of which audience) the users converted.

In some embodiments, users' contextual, geolocation, and device type features may be associated with their corresponding conversion labels across all audiences based on, e.g., the users' identifiers and an audience definition (e.g., BMW X audience of mobile web users in Canada is eligible when an ad opportunity is presented for a user browsing on a mobile phone in Canada). In some embodiments, a random selection was performed on such associated data to identify a certain volume (e.g., one million) of ad opportunities that resulted in conversions within a period (e.g., a week) of time, and a certain volume (e.g., one million) of ad opportunities which have not resulted in any conversions. Such resulting augmented dataset may then be packed into the sparse (LibSVM) data format and the corresponding vocabularies of features and labels may be generated.

Such generated data may then be used for training the XMLC ML model 230. In some embodiments, dimensionality reduction on representations of features may be performed. For example, a feature embedding lookup may be created such that every feature, representing a binary random variable Xⱼ from a vocabulary V_{feat}={X₁, X₂, . . . X_{D}}, is assigned an embedding vⱼ∈ [symbol] , such that M«D. The values of such created feature embeddings may be initialized with random uniform values. A mapping g:V_{feat}→ [symbol] is used to retrieve the embedding vⱼ=g(Xⱼ) of the feature Xⱼ, for every j=1, . . . , D. In formulating the learning, interactions among features may be considered according to the present teaching. When there is a larger number of features associated with each ad opportunity context, the feature interactions to be incorporated into the formulation may be limited to a certain extent. For example, in some situations, only second-degree feature interactions may be considered. This is illustrated in the following.

A decision function with a second-degree feature interaction may be defined as:

$$f ( x ) = {[ {w}_{0 , l} + {\sum }_{j = 1}^{D} {w}_{j , l} {x}_{j} ]}_{l = 1}^{L} + {[ {\sum }_{j = 1}^{\hat{D}} {\sum }_{k = j + 1}^{\hat{D}} {w}_{j , k , l}^{int} 〈 {v}_{{\hat{X}}_{j}} , {v}_{{\hat{X}}_{k}} 〉 {x}_{{\hat{X}}_{j}} {x}_{{\hat{X}}_{k}} ]}_{l = 1}^{L} \qquad ( 1 )$$

where w₀=[w_{0,1}, w_{0,2}, . . . , w_{0,L}] is an L-dimensional vector where w_{0,l} is the bias term for the l-th audience. W=[w_{j,l}]_{D×L} is a two-dimensional matrix in which entry w_{j,l} represents the weight of the j-th feature with respect to the l-th audience. W^{int}=[W_{j,k,l}^{int}]_{\hat{D}×\hat{D}×L}, is a three-dimensional matrix such that w_{j,k,l}^{int} is the strength of the interaction between the j-th and the k-th active feature. \hat{X} is a set with cardinality \hat{D} containing the indices of the active features of x. V is a D×M embedding matrix (applied to all audiences) in which each row vⱼ is the M-dimensional embedding for the j-th feature, meaning that v_{\hat{x}j} corresponds to the embedding the j-th active feature. In the above formulation, operator [symbol] ·,· [symbol] computes the dot product between the embeddings of two features as shown below:

$$〈 {v}_{{\hat{X}}_{j}} , {v}_{{\hat{X}}_{k}} 〉 = {\sum }_{m = 1}^{M} {u}_{{\hat{X}}_{j , m}} {u}_{{\hat{X}}_{k , m}} , \qquad ( 2 )$$

for each j, k=1, . . . , \hat{D}.

This extends the capacity of the linear formulation given by the first two separate terms of equation (1) and thus allows for modeling between-feature interactions. In this exemplary formulation, instead of using a separate parameter for each feature interaction with respect to each audience, the feature interactions are essentially modeled by factorizing the interaction strengths. This is one of the central benefits of factorization machine models which aids in obtaining estimates of the feature interaction values even when dealing with considerably sparse features, as is the case frequently with ad opportunity features.

To learn the parameters of the XMLC ML model 230, considering a dataset S={(x₁, y₁), (x₂, y₂), . . . , (x_{N}, y_{N})} of labeled contexts of ad opportunities, the categorical cross-entropy loss for the i-th context is defined as:

$$ℓ ( {x}_{i} , {y}_{i} ) = - \frac{1}{L} ( {\sum }_{l = 1}^{L} {y}_{i , l} ( log ( {ρ}_{i , l} ) ) + ( 1 - {y}_{i , l} ) ( 1 - log ( {ρ}_{i , l} ) ) ) \qquad ( 3 )$$

where p_{i,l}=P(y_{i,l}|xᵢ)=1/(1−e^{-ƒ(x}^{ᵢ₎}). The total loss for all ad opportunity contexts is defined as:

$$ℒ = \frac{1}{N} {\sum }_{i = 1}^{N} ℓ ( {x}_{i} , {y}_{i} ) . \qquad ( 4 )$$

In this exemplary formulation, a sigmoid function, instead of a softmax function, is used to obtain the conversion probabilities since an ad opportunity may result in conversions for multiple audiences. The parameters to be learned include the values of the embeddings for different features, as well as the model parameters w₀*, W*, W^{int*}, V*. Such parameters may be initially assigned with randomly initialized parameter values and adjusted in the learning process by minimizing the total loss calculated over all ad opportunity contexts in S.

This model and corresponding learning mechanism via multi-label factorization machine (MLFM) formulation has a space complexity of O(L+DM+\hat{D}LM+L\hat{D}(\hat{D}−1)/2), where D is the number of features, \hat{D} is the number of active features, M is the feature embedding dimension, and L is the number of audience segments. Similarly, the time complexity becomes asymptotically linear in terms of \hat{D} and M, i.e., O(\hat{D}M).

As depicted in FIG. 3, the XMLC ML model 230 is generated by the XMLC ML model training unit 350 via learning from the training data created based on the data archived in data storage 340 continually collected from ad serving operations. Exemplary implementations of the XMLC ML model training unit 350 are described with reference to FIGS. 5-6. FIG. 5 depicts an exemplary high level system diagram of the XMLC ML model training unit 350, in accordance with an exemplary embodiment of the present teaching. In this exemplary implementation, the model training unit 350 comprises a raw data processor 510, a training data generator 520, a context feature vector initializer 530, a model weight initializer 550, a machine learning controller 560, a loss determiner 570, and a model parameter optimizer 580. The raw data processor 510 may be provided to process the archived raw data from data storage 340 in order to produce the compliant data required by other components in the training unit 350 to further utilize the data.

The training data generator 520 may be provided to organize the data into a form that is needed for further processing. For instance, each of the ad opportunity contexts needs to be pairs with a corresponding label, representing the outcome performance after the ad display to form S={(x₁, y₁), (x₂, y₂), . . . , (x_{N}, y_{N})} etc. As another example, each of the ad opportunity contexts, xᵢ may be encoded as a one hot vector and then mapped to an embedding of a reduced dimension. The context feature vector initializer 530 may be provided to initialize the values of embeddings representing the features in the training ad opportunity contexts. The initialization of embeddings may be according to a profile stored in 540 that specifies the scheme used for initializing the embeddings. For instance, the profile may specify to use randomly generated numbers as initial values of the embeddings. Other profiles for initialization of embeddings may also be specified in 540 so that the learning mechanism can be flexibly adapted to a different scheme in operation.

The initialized embedding values may be stored in the XMLC ML model 230 as the initial state. At the same time, various weights used in the XMLC ML model 230, e.g., the model parameters w₀*, W*, W^{int*}, V*, may be initialized by the model weight initializer 550. Similarly, such initialization may also be performed based on a scheme specified by the configured profile in 540. For instance, initial model weights may be assigned a certain number, i.e., everything weighted equally. Once the model parameters of the XMLC ML model 230 are initialized, they are stored as current model parameters in 230. To learn the model parameters, the machine learning controller 560 manages an iterative learning process. It invokes the loss determiner 570 and model parameter optimizer 580 in each iteration. For example, based on the current model parameters in 230, the loss determiner 570 may compute the loss during each iteration based on a specified loss function defined in a profile stored in the learning control profiles 540. Then the model parameter optimizer 580 determines, based on the loss computed, how to adjust the model parameters to minimize the loss. If the loss indicates that the learning has not converged, another iteration starts by computing a loss based on adjusted model parameters. The machine learning controller 560 may control the learning process in accordance with some convergence condition, e.g., a level of loss defining convergence, specified in a learning control profile stored in 540. The learning process may not stop until the convergence condition is met.

FIG. 6 is a flowchart of an exemplary process of the XMLC ML model training unit 350, in accordance with an exemplary embodiment of the present teaching. To initiate the learning, upon retrieving archived data from data storage 340, the raw data processor 510 processes, at 610, the data and sends the processed data to the training data generator 520, which then generates, at 620, training data in a form required by the learning process. As discussed herein, examples of converting training data to the form for training include pairing ad opportunities with their corresponding labels and mapping the ad opportunity contexts' one hot vector representations to embeddings. Such training data may then be initialized, at 630, as a starting point for the training. This includes initialization of the embedding values by the context feature vector initializer 530 and the initialization of the model weights by the model weight initializer 550.

Based on the initialized model parameters (including both embedding values as well as model weights), the machine learning controller 560 controls an iterative learning process involving steps 640-690. Specifically, the loss determiner 570 computes, at 640, the loss based on the current model parameters. It is then determined, at 650, whether the loss satisfies a convergence condition. If the loss does not satisfy the convergence condition, it means that the model parameters are not yet optimal and the model parameter optimizer 580 then proceeds to adjust, at 660, the model parameters by minimizing the loss. Once the model parameters are adjusted, the adjusted model parameters are stored in 230 for the next round of learning. To do so, the processing proceeds to step 640 to compute the loss based on the updated model parameters. The iterations continue until the learning converges, i.e., the loss meets the convergence condition, determined at 650. For instance, the loss may meet the convergence condition when the loss is below a pre-determined threshold. In this case, the current model parameters are converged, and they are stored, at 670, in 230 to represent the learned XMLC ML model 230.

As the data collection is continuing from the ad serving operations, the trained XMLC ML model 230 may need to be adapted to a new environment or situation. Such adaptation may be regularly scheduled or dynamically activated when, e.g., there are enough new data collected from the ad serving operations. Thus, after the XMLC ML model 230 is learned and used in ad serving applications, it may be checked, either regularly or dynamically, whether additional training (adaptation) is needed at 680. If so, the process proceeds to step 610 to conduct another round of learning to produce XMLC ML model 230 that is adapted to the new training data.

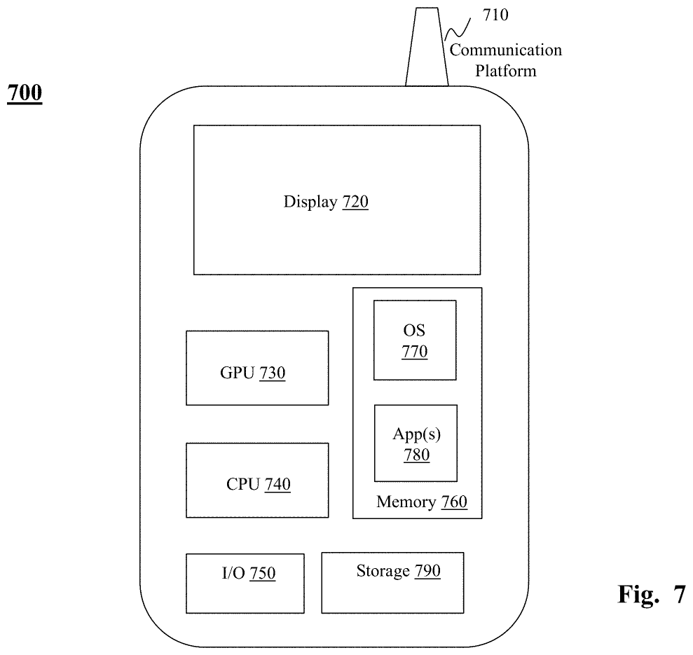

FIG. 7 is an illustrative diagram of an exemplary mobile device architecture that may be used to realize a specialized system implementing the present teaching in accordance with various embodiments. In this example, the user device on which the present teaching may be implemented corresponds to a mobile device 700, including, but not limited to, a smart phone, a tablet, a music player, a handheld gaming console, a global positioning system (GPS) receiver, and a wearable computing device, or in any other form factor. Mobile device 700 may include one or more central processing units (“CPUs”) 740, one or more graphic processing units (“GPUs”) 730, a display 720, a memory 760, a communication platform 710, such as a wireless communication module, storage 790, and one or more input/output (I/O) devices 750. Any other suitable component, including but not limited to a system bus or a controller (not shown), may also be included in the mobile device 700. As shown in FIG. 7, a mobile operating system 770 (e.g., iOS, Android, Windows Phone, etc.), and one or more applications 780 may be loaded into memory 760 from storage 790 in order to be executed by the CPU 740. The applications 780 may include a user interface or any other suitable mobile apps for information analytics and management according to the present teaching on, at least partially, the mobile device 700. User interactions, if any, may be achieved via the I/O devices 750 and provided to the various components connected via network(s).

To implement various modules, units, and their functionalities described in the present disclosure, computer hardware platforms may be used as the hardware platform(s) for one or more of the elements described herein. The hardware elements, operating systems and programming languages of such computers are conventional in nature, and it is presumed that those skilled in the art are adequately familiar with them to adapt those technologies to appropriate settings as described herein. A computer with user interface elements may be used to implement a personal computer (PC) or other type of workstation or terminal device, although a computer may also act as a server if appropriately programmed. It is believed that those skilled in the art are familiar with the structure, programming, and general operation of such computer equipment and as a result the drawings should be self-explanatory.

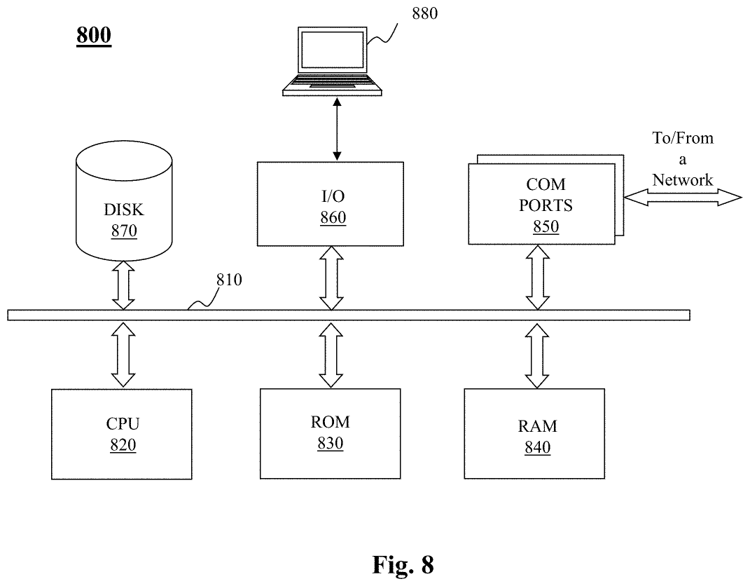

FIG. 8 is an illustrative diagram of an exemplary computing device architecture that may be used to realize a specialized system implementing the present teaching in accordance with various embodiments. Such a specialized system incorporating the present teaching has a functional block diagram illustration of a hardware platform, which includes user interface elements. The computer may be a general-purpose computer or a special purpose computer. Both can be used to implement a specialized system for the present teaching. This computer 800 may be used to implement any component or aspect of the framework as disclosed herein. For example, the information analytical and management method and system as disclosed herein may be implemented on a computer such as computer 800, via its hardware, software program, firmware, or a combination thereof. Although only one such computer is shown, for convenience, the computer functions relating to the present teaching as described herein may be implemented in a distributed fashion on a number of similar platforms, to distribute the processing load.

Computer 800, for example, includes COM ports 850 connected to and from a network connected thereto to facilitate data communications. Computer 800 also includes a central processing unit (CPU) 820, in the form of one or more processors, for executing program instructions. The exemplary computer platform includes an internal communication bus 810, program storage and data storage of different forms (e.g., disk 870, read only memory (ROM) 830, or random-access memory (RAM) 840), for various data files to be processed and/or communicated by computer 800, as well as possibly program instructions to be executed by CPU 820. Computer 800 also includes an I/O component 860, supporting input/output flows between the computer and other components therein such as user interface elements 880. Computer 800 may also receive programming and data via network communications.

Hence, aspects of the methods of information analytics and management and/or other processes, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, in connection with information analytics and management. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

Those skilled in the art will recognize that the present teachings are amenable to a variety of modifications and/or enhancements. For example, although the implementation of various components described above may be embodied in a hardware device, it may also be implemented as a software only solution, e.g., an installation on an existing server. In addition, the techniques as disclosed herein may be implemented as a firmware, firmware/software combination, firmware/hardware combination, or a hardware/firmware/software combination.

While the foregoing has described what are considered to constitute the present teachings and/or other examples, it is understood that various modifications may be made thereto and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method implemented on at least one processor, a memory, and a communication platform for predictive targeting, comprising:
obtaining training data comprising pairs of data, each of the pairs includes an ad opportunity context corresponding to an ad served to a plurality of audiences and a label vector having a plurality of labels, each of which indicates a reaction, with respect to the ad served, of a corresponding one of the plurality of audiences in the ad opportunity context;
initializing a joint predictive model with initial model parameters; and
machine learning, based on the training data, model parameters of the joint predictive model based on the initial model parameters by minimizing a loss in an iterative process, wherein
the learned joint predictive model is to be used to map an input context of an ad opportunity to an output label vector having a plurality of probabilities, each of which predicts a likelihood of a reaction of a corresponding one of the plurality of audiences to the input context of the ad opportunity.

2. The method of claim 1, wherein
the reaction includes one of a conversion and a lack of conversion; and
a label in the label vector indicates whether the reaction is a conversion or a lack of conversion.

3. The method of claim 1, wherein an ad opportunity context is characterized based on a plurality of contextual features, wherein
each contextual feature is encoded via a first representation of a first dimension, and
each first representation is characterized by a feature vector of a second dimension, wherein the first dimension is larger than the second dimension.

4. The method of claim 3, wherein the joint predictive model is constructed to predict an output label vector by
representing
each contextual feature of an ad opportunity context via the first representation weighted by a first coefficient, and
each first representation via the feature vector; and
incorporating interactions between feature vectors of different contextual features of each ad opportunity context weighted by a second set of coefficients.

5. The method of claim 4, wherein the step of initializing comprises:
initializing values of feature vectors related to the plurality of contextual features; and
initializing values of the first coefficients used to weigh the corresponding plurality of contextual features; and
initializing values of the second set of coefficients used to weigh the interactions.

6. The method of claim 1, wherein the step of machine learning comprises:
obtaining an ad opportunity context from a pair of data in the training data;
predicting an output label vector with a plurality of probabilities based on current model parameters of the joint predictive model, wherein each probability of the output label vector indicates a likelihood of a reaction from a corresponding one of the plurality of audiences;
computing a loss based on the predicted output label vector and the label vector from the pair of data from the training data;
adjusting the current model parameters of the joint predictive model by minimizing the loss, wherein
the steps of obtaining, predicting, computing, and adjusting are repeated in the iterative process until the loss satisfies a pre-determined criterion to generate the joint predictive model with converged model parameters.

7. The method of claim 1, further comprising:
receiving, from a demand side platform (DSP), an input context of an ad opportunity;
creating first representations for corresponding contextual features of the input context of the ad opportunity;
generating an output label vector with respect to the plurality of audiences, based on the joint predictive model with converged model parameters, to predict probabilities of reactions of the respective plurality of audiences to the ad opportunity context;
transmitting the output label vector to the DSP to enable the DSP to select one or more of the plurality of audiences based on the predicted probabilities in the output label vector.

8. Machine readable and non-transitory medium having information recorded thereon for predictive targeting, wherein the information, when read by the machine, causes the machine to perform the steps of:
obtaining training data comprising pairs of data, each of the pairs includes an ad opportunity context corresponding to an ad served to a plurality of audiences and a label vector having a plurality of labels, each of which indicates a reaction, with respect to the ad served, of a corresponding one of the plurality of audiences in the ad opportunity context;
initializing a joint predictive model with initial model parameters; and
machine learning, based on the training data, model parameters of the joint predictive model based on the initial model parameters by minimizing a loss in an iterative process, wherein
the learned joint predictive model is to be used to map an input context of an ad opportunity to an output label vector having a plurality of probabilities, each of which predicts a likelihood of a reaction of a corresponding one of the plurality of audiences to the input context of the ad opportunity.

9. The medium of claim 8, wherein
the reaction includes one of a conversion and a lack of conversion; and
a label in the label vector indicates whether the reaction is a conversion or a lack of conversion.

10. The medium of claim 8, wherein an ad opportunity context is characterized based on a plurality of contextual features, wherein
each contextual feature is encoded via a first representation of a first dimension, and
each first representation is characterized by a feature vector of a second dimension, wherein the first dimension is larger than the second dimension.

11. The medium of claim 10, wherein the joint predictive model is constructed to predict an output label vector by
representing
each contextual feature of an ad opportunity context via the first representation weighted by a first coefficient, and
each first representation via the feature vector; and
incorporating interactions between feature vectors of different contextual features of each ad opportunity context weighted by a second set of coefficients.

12. The medium of claim 11, wherein the step of initializing comprises:
initializing values of feature vectors related to the plurality of contextual features; and
initializing values of the first coefficients used to weigh the corresponding plurality of contextual features; and
initializing values of the second set of coefficients used to weigh the interactions.

13. The medium of claim 8, wherein the step of machine learning comprises:
obtaining an ad opportunity context from a pair of data in the training data;
predicting an output label vector with a plurality of probabilities based on current model parameters of the joint predictive model, wherein each probability of the output label vector indicates a likelihood of a reaction from a corresponding one of the plurality of audiences;
computing a loss based on the predicted output label vector and the label vector from the pair of data from the training data;
adjusting the current model parameters of the joint predictive model by minimizing the loss, wherein
the steps of obtaining, predicting, computing, and adjusting are repeated in the iterative process until the loss satisfies a pre-determined criterion to generate the joint predictive model with converged model parameters.

14. The medium of claim 8, wherein the information, when read by the machine, further causes the machine to perform the steps of:
receiving, from a demand side platform (DSP), an input context of an ad opportunity;
creating first representations for corresponding contextual features of the input context of the ad opportunity;
generating an output label vector with respect to the plurality of audiences, based on the joint predictive model with converged model parameters, to predict probabilities of reactions of the respective plurality of audiences to the ad opportunity context;
transmitting the output label vector to the DSP to enable the DSP to select one or more of the plurality of audiences based on the predicted probabilities in the output label vector

15. A system for predictive targeting, comprising:
a training data generator configured for generating training data comprising pairs of data, each of the pairs includes an ad opportunity context corresponding to an ad served to a plurality of audiences and a label vector having a plurality of labels, each of which indicates a reaction, with respect to the ad served, of a corresponding one of the plurality of audiences in the ad opportunity context;
a model initializer configured for initializing a joint predictive model with initial model parameters; and
a machine learning controller configured for machine learning, based on the training data, model parameters of the joint predictive model based on the initial model parameters by minimizing a loss in an iterative process, wherein
the learned joint predictive model is to be used to map an input context of an ad opportunity to an output label vector having a plurality of probabilities, each of which predicts a likelihood of a reaction of a corresponding one of the plurality of audiences to the input context of the ad opportunity.

16. The system of claim 15, wherein
the reaction includes one of a conversion and a lack of conversion; and
a label in the label vector indicates whether the reaction is a conversion or a lack of conversion.

17. The system of claim 15, wherein an ad opportunity context is characterized based on a plurality of contextual features, wherein
each contextual feature is encoded via a first representation of a first dimension, and
each first representation is characterized by a feature vector of a second dimension, wherein the first dimension is larger than the second dimension.

18. The system of claim 17, wherein the joint predictive model is constructed to predict an output label vector by
representing
each contextual feature of an ad opportunity context via the first representation weighted by a first coefficient, and
each first representation via the feature vector; and
incorporating interactions between feature vectors of different contextual features of each ad opportunity context weighted by a second set of coefficients.

19. The system of claim 18, wherein the model initializer comprises:
a context feature vector initializer configured for initializing values of feature vectors related to the plurality of contextual features; and
a model weight initializer configured for initializing
values of the first coefficients used to weigh the corresponding plurality of contextual features, and
values of the second set of coefficients used to weigh the interactions.

20. The system of claim 15, wherein the machine learning controller is configured for performing:
obtaining an ad opportunity context from a pair of data in the training data;
predicting an output label vector with a plurality of probabilities based on current model parameters of the joint predictive model, wherein each probability of the output label vector indicates a likelihood of a reaction from a corresponding one of the plurality of audiences;
computing a loss based on the predicted output label vector and the label vector from the pair of data from the training data;
adjusting the current model parameters of the joint predictive model by minimizing the loss, wherein
the steps of obtaining, predicting, computing, and adjusting are repeated in the iterative process until the loss satisfies a pre-determined criterion to generate the joint predictive model with converged model parameters.
